(19) United States
(12) Patent Application Publication
(10) Pub. No.: US 2013/0180224 A1
(43) Pub. Date: Jul. 18, 2013

(54) DROPLET SHAPED FILTER FOR BAGHOUSE

(71) Applicant: Tian Xuan Zhang, Overland Park, KS (US)

(72) Inventor: Tian Xuan Zhang, Overland Park, KS (US)

(73) Assignee: BHA Group, Inc., Kansas City, MO (US)

(21) Appl. No.: 13/350,960

(22) Filed: Jan. 16, 2012

(51) Int. Cl. B01D 46/02; B01D 46/52

(52) U.S. Cl. 55/500

(57) ABSTRACT

A filter element includes a filter media extending along a longitudinal axis and extending circumferentially about a central passageway that extends along the longitudinal axis. The filter media defines a droplet cross-sectional shape perpendicular to the longitudinal axis. Alternatively, the filter media defines a top portion shape and a bottom portion shape, with the top and bottom cross-sectional portion shapes being asymmetric with respect to each other. The filter element may be used in a filtration arrangement for filtering dust flow. The filtration arrangement also includes a filter housing that has an opening through which dust flow is configured to enter the filter housing.

### BACKGROUND OF THE INVENTION

1. Field of the Invention

The present invention relates generally to a filter device, and more particularly, to a shaped filter element that reduces particle accumulation on a surface of the filter element.

2. Discussion of the Prior Art

Air filters are known and used in many different applications, including baghouses. Each baghouse may be provided with one or more air filters extending within the baghouse for filtering dirty air in various environments. Current technology filters include pleated filter media that has a substantially circular cross-sectional shape. However, particles that have been filtered from the dirty air can accumulate near a top surface of the filter media. This particle accumulation can reduce the efficiency and lifespan of the filters. For instance, it can be difficult to remove particles that have accumulated on the filters and may require taking the baghouse out of service to clean the filters. Furthermore, this particle accumulation can cause a pressure drop across the filter element and excessive wear at the top surface of the filter element. Accordingly, it would be useful to provide a filter element that reduces particle accumulation on the surface of the filter element. Additionally, it would be useful to provide a filter element that solves the aforementioned problem while still being able to be used in a conventional baghouse environment.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter element that includes a filter media extending along a longitudinal axis and extending circumferentially about a central passageway that extends along the longitudinal axis. The filter media defines a droplet cross-sectional shape perpendicular to the longitudinal axis.

In accordance with another aspect, the present invention provides a filter media extending along a longitudinal axis and circumferentially about a central passageway that extends along the longitudinal axis, the filter media defining a top portion shape and a bottom portion shape, the top and bottom portion shapes being asymmetric with respect to each other in a cross-sectional plane that is perpendicular to the longitudinal axis.

In accordance with another aspect, the present invention provides a filtration arrangement for filtering dust flow. The filtration arrangement includes a filter housing that has an opening through which dust flow is configured to enter the filter housing. The arrangement includes a filter media extending along a longitudinal axis and extending circumferentially about a central passageway that extends along the longitudinal axis. The filter media defines a droplet cross-sectional shape perpendicular to the longitudinal axis.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is an exploded, schematized perspective view of an example filtration arrangement having a plurality of example filter element in accordance with at least one aspect of the present invention;

FIG. 2 is a schematized perspective view of one example filter element in accordance with an aspect of the present invention;

FIG. 3 is a cross-sectional view of the example filter element along line 3-3 of FIG. 2; and

FIG. 4 is a sectional view of a prior art filter element.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

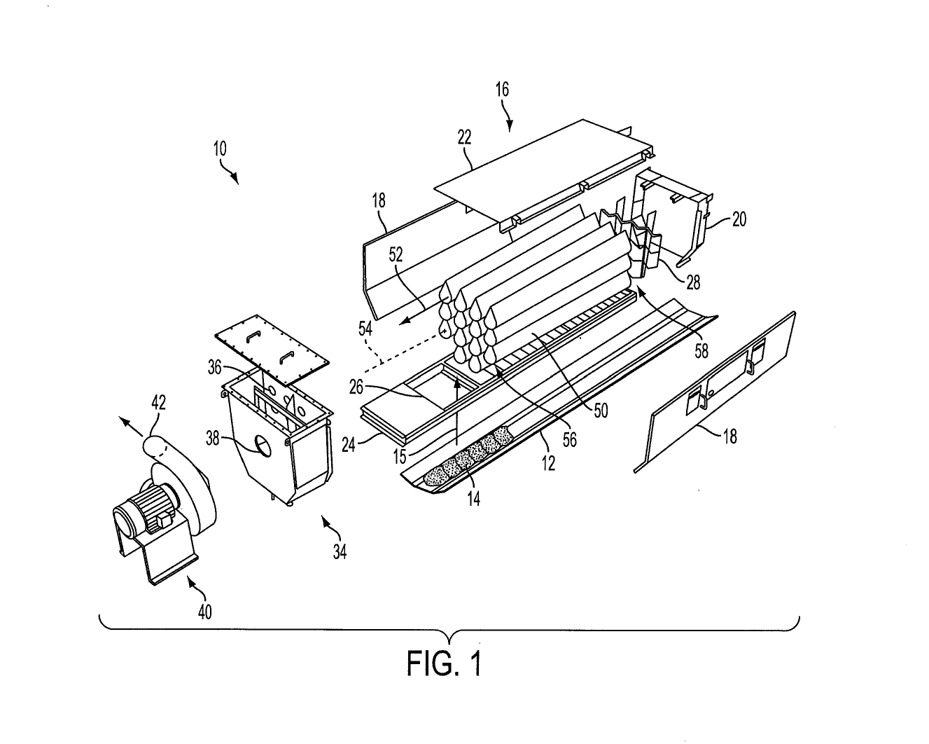

FIG. 1 illustrates an example filtration arrangement 10 for use in an industrial environment. One or more filter elements 50 are provided within the filtration arrangement 10. Within the shown example, a plurality of filter elements 50 are provided within the filtration arrangement 10. In short summary, an air-borne particulate, such as dust, flows or proceeds (see arrowhead 15) toward the plurality of filter elements 50, the air-borne particulate (e.g., dust) 15 can be filtered by the filter elements 50, and filtered air 52 proceeds therefrom. Hereinafter the air-borne particulate is simply referred to as dust, but with the understanding that various air-borne particulates can be present and thus filtered. As is to be expected, the dust accumulates upon the outer surface of the filter elements 50 during operation. In accordance with an aspect of the present invention, the shape of the filter elements 50 can reduce an amount of accumulated dust on an outer surface of the filter elements 50.

Turning to the specific example shown with FIG. 1, the filtration arrangement 10 can be positioned above a belt assembly 12 that transports a conveyed material 14, such as mill feed or the like. The filtration arrangement 10 includes a filter housing 16 located above the belt assembly 12 and within which the filter elements 50 are located. The belt assembly 12 can include a movable belt that transports the conveyed material 14 from one location to another. Due, in part, to the movement and vibration of the conveyed material 14 by the belt assembly 12, dust or particulates are emitted into the air from the conveyed material 14. The belt assembly 12 and conveyed material 14 are generically shown in FIG. 1 and can include a variety of different structures. For instance, an assortment of conveyor structures are contemplated that can transport a number of different materials. As such, the belt assembly 12 and conveyed material 14 in the shown example are not intended to be limiting on further examples. The filtration arrangement 10 can be incorporated into a variety of industrial or non-industrial environments. For example, the filtration arrangement 10 can be used in areas that have a relatively high amount of dust or particulate-laden air, such as mills, or the like, in order to remove the dust or particulates from the air.

Focusing upon the function of the filtration arrangement 10, the dust proceeds (see arrowhead 15) from the conveyed material 14 and is drawn into the filter housing 16, whereupon the dust is filtered by the filter elements 50. It is to be appreciated that the filtration arrangement 10 is somewhat generically/schematically shown within FIG. 1. Also, it is to be appreciated that FIG. 1 is an exploded view of the filtration arrangement 10 for illustrative purposes to show the structural relationship between components within the filtration arrangement 10. It is to be understood, however, that in operation, the filtration arrangement 10 is in a fully assembled state.

It is to be noted that, in one example, the filtration arrangement 10, and the filter elements 50 therein, can have a horizontal orientation. Nevertheless, since FIG. 1 merely presents one example, the filtration arrangement 10 can include a variety of different horizontally-oriented configurations and is not limited to the shown example. Rather, the horizontal orientation of the filter elements 50 can encompass a variety of different orientations within the within the filtration arrangement 10. For example, the filter elements 50 can extend in a substantially horizontal orientation between a range of from about +/−45° with respect to a horizontal plane. However, the filter elements 50 are not limited to such a range, and could, in further examples, be oriented at an even larger angle with respect to the horizontal plane. Accordingly, it is to be understood that the horizontal orientation of the filter elements 50 is a relatively broad term and need not be limited to extending along a horizontal plane.

The filter housing 16 defines an internal chamber surrounded by a plurality of panels. The panels can include side panels 18, an end panel 20, a top panel 22, and a bottom panel 24. In a fully assembled state, the panels can be attached to each other to form a substantially closed environment, such that air is limited to entering and exiting the filter housing 16 through designated openings. One or more of the panels can be selectively removable, such that a user can have access to the internal chamber of the filter housing 16. The bottom panel 24 can include an opening 26 through which air can pass from an exterior to the internal chamber of the filter housing 16. The opening 26 can include a variety of sizes and shapes, and is not limited to the opening 26 in the shown example. The filter housing 16 can further include a support plate 28 positioned adjacent the end panel 20. The support plate 28 can be attached to the end panel 20 and can support an end of each of the filter elements 50.

The filtration arrangement 10 can further include an end wall assembly 34. The end wall assembly 34 can be positioned at an opposite end of the filter housing 16 from the end panel 20. The end wall assembly 34 can be attached to the side panels 18, top panel 22, and bottom panel 24, such that the end wall assembly 34 defines a closed end of the filter housing 16. The end wall assembly 34 defines an internal chamber surrounded by one or more walls. The end wall assembly 34 can include one or more filter openings 36 extending through a wall of the end wall assembly 34. The filter openings 36 can be arranged adjacent the internal chamber of the filter housing 16 such that the end wall assembly 34 can be in fluid communication with the filter housing 16. The number of filter openings 36 typically corresponds to the number of filter elements 50. It is to be understood that the filter openings 36 are only generically shown examples within FIG. 1 and could have variations in size and shape. In particular, the size/shape of the filter openings 36 can be complementary to the size/shape of the filter elements 50 as described herein. However, the size/shape of the filter openings 36 need not be precisely complementary to the size/shape of the filter elements 50.

The end wall assembly 34 can further include a fan opening 38. The fan opening 38 can be positioned on a wall opposite from the one or more filter openings 36. The fan opening 38 is shown as a single fan opening, however a plurality of fan openings are contemplated. Similarly, in further examples, the fan opening 38 is not limited to the positioning of the shown example, and could be arranged on a side wall, top wall, or the like. The fan opening 38 can provide an air passageway from an exterior of the end wall assembly 34 to the interior chamber of the end wall assembly 34. As such, the fan opening 38 can be in fluid communication with the one or more filter openings 36, such that air, dust flow, or the like can pass from the one or more filter openings 36, through the end wall assembly 34, and through the fan opening 38.

The filtration arrangement 10 can further include a fan assembly 40. The fan assembly 40 can be attached to the fan opening 38, such that the fan assembly 40 and fan opening 38 are in fluid communication. The fan assembly 40 can draw air from the end wall assembly 34 through the fan opening 38 such that a negative pressure is generated within the end wall assembly 34. Air within the end wall assembly 34 can be drawn into the fan assembly 40 and emitted through a fan outlet 42.

The example shown in FIG. 1 includes a plurality of filter elements 50; however, it is to be understood that the filtration arrangement 10 can include any number (i.e., one or more) of filter elements 50. The filter elements 50 are positioned within the internal chamber of the filter housing 16. The filter elements 50 are each generally elongate and may be arranged parallel (e.g., along their axes of elongation) to each other in a substantially horizontal manner. Specifically, each filter element 50 can each extend along a longitudinal axis 54 that extends along a substantially horizontal direction. In further examples, however, it is to be understood that the filter elements 50 may extend in a somewhat non-horizontal orientation, such as in a range of from about +/−45° with respect to a horizontal plane.

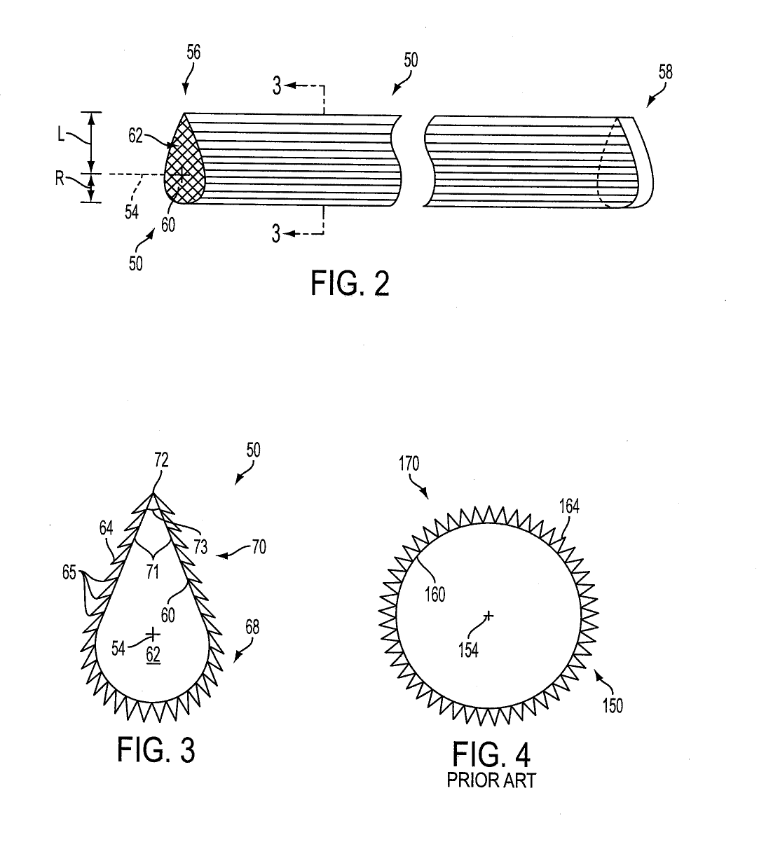

It is to be understood that the one or more filter elements 50 are somewhat generically shown in FIG. 1 for clarity and illustrative purposes, and are more clearly shown in FIGS. 2 and 3. For example, the one or more filter elements 50 are not limited to the orientation shown within the filtration arrangement 10. Instead, in a further example, one or more rows of the filter elements 50 could be staggered with respect to rows of filter elements 50 above and/or below. As such, one row of filter elements 50 could be positioned at an offset vertical location with respect to the rows of filter elements 50 above and/or below. Accordingly, particulate matter can fall from the filter elements 50 without landing on filter elements 50 located below.

The filter elements 50 can include an open end 56 and a closed end 58. The closed end 58 of the filter elements 50 can be supported by the support plate 28. The closed end 58 can be sealed, such that air flow and/or fluid flow is limited or prevented from flowing through the closed end 58 and into the filter elements 50. The closed end 58 can be supported in any number of ways, such that the closed end 58 can be fixedly held with movement of the closed end 58 being limited.

The open end 56 of the filter elements 50 can define an opening, passageway, or the like that allows the filtered air 52 (see arrowhead, FIG. 1) to exit the filter elements 50 through the open end 56. The open end 56 can be attached to the end wall assembly 34. Specifically, the open end 56 of the filter elements 50 can be attached to the filter openings 36 of the end wall assembly 34. The open end 56 can be attached in any number of ways, including, for example, mechanical fastening devices, or the like. Accordingly, the open end 56 can be in fluid communication with the filter openings 36 such that filtered air 52 can flow from an internal chamber of the filter elements 50 and through the filter openings 36.

Referring now to FIGS. 2 and 3, the structure of an example filter element 50 can now be more fully described. While FIGS. 2 and 3 show a single filter element, it is to be understood that some or all of the remaining filter elements shown in FIG. 1 can have a similar and/or identical shape to the filter element in the shown example. As such, the filter element 50 shown in FIGS. 2 and 3 can represent some or all of the remaining filter elements in FIG. 1. Further, it is to be understood that the filter element 50 is somewhat generically shown within FIGS. 2 and 3, and could take on a variety of constructions, sizes, and shapes in accordance with one or more aspects of the present invention.

The filter element 50 can include a scrim 60 through which air can flow. The scrim 60 defines and bounds a central passageway 62 formed within the filter element 50. The scrim 60 and the central passageway 62 can extend along the longitudinal axis 54. The longitudinal axis 54 extends in a substantially horizontal direction within the filtration arrangement 10, such that the central passageway 62 and the scrim 60 also extend in a substantially horizontal direction. On a cross-section that is taken perpendicular to the longitudinal axis 54 the scrim 60 defines a shape. This cross-sectional shape of the scrim 60 can be configured to define a variety of shapes and sizes, but in the shown example, the scrim 60 defines a droplet cross-sectional shape. The droplet shape, described in detail below, has a bottom portion that can define a substantially semi-circular shape and a top portion that can define a substantially non-circular shape. For example, the droplet shape can include a number of different shapes and sizes. In further examples, the droplet shape can include the bottom portion having a V-like shape, inwardly extending W-like shapes, a flat bottom shape, or the like. It is to be understood, however, that the droplet shape is not limited to the example shown and described herein, and could include other shapes.

The scrim 60 could be made of a number of different metal materials, such as steel, titanium, a mesh-like wire material, or the like. The scrim 60 may be sufficiently stiff to provide some support to the filter element 50, such that the scrim 60 functions as a support device. The scrim 60 can also be porous and include openings on the surface to allow for the passage of air through the scrim 60 to the central passageway 62. For instance, the scrim 60 may include a plurality of perforations, apertures, holes, etc. to allow air to pass from the exterior of the filter element 50 to the central passageway 62.

The filter element 50 includes a filter media 64 for removing dust from the air passing through the filter element 50. The filter media 64 is arranged around the scrim 60 and thus arranged around the longitudinal axis 54. The filter media 64 can be limited and/or prevented from radial inward movement into the central passageway 62 by the scrim 60. The filter media 64 can be attached to the scrim 60 in a number of ways, including an adhesive, such that the filter media 64 can be non-removably secured to the scrim 60. In further examples, the filter element 50 could include a support device, retaining strap, or the like (not shown), that is positioned on an outside edge of the filter media 64. The support device, retaining strap, or the like can limit and/or prevent the filter media 64 from radial outward movement away from the central passageway 62. It is to be appreciated that although the presented example includes a scrim 60, it is contemplated that the filter element 50 need not have a scrim 60 and may be provided solely with a filter media. In such further examples, the filter media 64 can be self-supporting and an inner surface of the filter media 64 will define the inner-most surface of the filter element 50.

The filter media 64 can be formed of a number of different materials. For instance, the filter media 64 can include a variety of filtering materials that function to remove particulates, including dust, from air that passes through the filter media 64. The filter media 64 can further include a hydrophobic media. In further examples, the filter media 64 could include a layer or coating of hydrophobic media deposited on either or both of the inner surface and outer surface of the filter media 64. In one example, the filter media 64 can include polytetrafluoroethylene (PTFE) or expanded polytetrafluoroethylene (ePTFE). However, a variety of materials are contemplated that can function to limit and/or prevent the passage of liquid through the filter media 64. As such, the filter media 64 can reduce and/or prevent the passage of target dust (particulates) from air while simultaneously reducing and/or preventing the passage of liquid through the filter media 64. In these examples, the filtered particulates and/or the liquid can accumulate on the outer surface of the filter media 64.

The filter media 64 can include a plurality of pleats 65 that are elongated parallel to the longitudinal axis 54. The pleats 65 can extend in a substantially zig-zag pattern generally toward and away from the longitudinal axis 54. For instance, in a circumferential direction around the longitudinal axis 54 and central passageway 62, the pleats 65 can alternately project inwardly towards the longitudinal axis 54 then project outwardly away from the longitudinal axis 54. The pleats 65 can further define a trough portion formed between the outer surfaces of adjacent pleats. As shown in FIG. 3, in one example, the pleats 65 can project in a slightly downward orientation with respect to the scrim 60. The pleats 65 can project downwardly in a direction towards a bottom portion 68. This downward orientation of the pleats 65 can induce or allow particulate buildup, such as dust, to naturally fall from the outer surface of the filter media 64 under the influence of gravity in accordance with an aspect of the invention. In addition, the downward orientation of the pleats 65 can facilitate shedding of dust, particle buildup, or the like, such that the dust and particle buildup are less likely to accumulate on the pleats 65 than if the pleats extended outwardly from the scrim 60 in a non-downward orientation.

The filter element 50 extends along the longitudinal axis 54 and can include a droplet shaped cross-section in accordance with an aspect of the invention, with the cross-section being taken perpendicular to the longitudinal axis 54. More specifically, the scrim 60 can form a droplet shaped cross-section such that the filter media 64 disposed on the scrim 60 can together form the filter element 50 having the droplet shaped cross-section. The filter element 50 can include the bottom portion 68 and a top portion 70 that, together, form the droplet shape in cross-section. The bottom portion 68 can define a bottom surface of the filter element 50. The bottom portion 68 of the filter element 50 can, in one example, include a substantially non-linear shape, such as a rounded shape in cross-section. The rounded shape of the bottom portion 68 can define a semi-circle, such as a half-circle, though angles larger or smaller than 180° are also contemplated. The bottom portion 68 can include a substantially constant radius of curvature (R) extending from the longitudinal axis 54 at a center of the filter element 50. The bottom portion 68 is somewhat generically represented in FIGS. 2 and 3, such that varying sizes and shapes are contemplated.

In further examples, the bottom portion 68 is not limited to the spherically rounded shape with the radius of curvature (R) described herein, and could include an oval shape, pointed shape, or the like. Along these lines, the bottom portion 68 may include a number of different substantially non-linear shapes that can have a non-constant radius of curvature. For example, the bottom portion 68 can include a V-like shape with substantially planar walls extending towards a bottom apex. Alternatively, the bottom portion 68 could include an inwardly extending W-like shape in which a center of the bottom portion 68 extends inwardly towards the longitudinal axis. Even further, the bottom portion 68 could have a substantially flat bottom shape, in which the bottom portion 68 comprises a substantially planar surface, or the like. It is to be understood, however, that further shapes of the bottom portion 68 are envisioned, such that the filter element 50 is not limited to the example shapes and sizes described herein.

The filter element 50 further includes the top portion 70 positioned opposite from the bottom portion 68. The top portion 70 can define a top surface of the filter element 50. As described in detail below, the top portion 70 of the filter element 50 can, in one example, be asymmetric from the bottom portion 68 (i.e., different distances from the axis). The top portion 70 can include a tapered shape that may be non-circular or non-spherical.

The tapered shape of the top portion 70 can include an apex 72. The apex 72 can be formed at a maximum radial distance from the longitudinal axis 54 and from the bottom portion 68. The apex 72 can include an internal angle 73 that is less than 90°, though a variety of angles are contemplated. The apex 72 can, in one example, be formed by top portion walls 71. As will be described below, in some examples, the top portion walls 71 can be straight while in other cases, the top portion walls 71 can be rounded such that the apex 72 is a discontinuity between the walls. In further examples, the apex 72 may be located on a round wall, with the apex 72 being the point of greatest distance from the longitudinal axis. The apex 72 may also not include an internal angle. Rather, the apex 72 can include a region comprising upper portions of the top portion walls 71.

The top portion 70 can include the top portion walls 71 that can form a substantially non-circular shape. The top portion walls 71 can be substantially linear in shape and can be positioned at opposing top sides of the filter element 50. By having a substantially linear shape, the top portion walls 71 can be straight or could be slightly rounded. The top portion walls 71 can each project from the bottom portion 68 at a lower end towards the apex 72 at an opposing top end. As such, the top portion walls 71 can each project between the bottom portion 68 and the apex 72.

In the shown examples, the top portion 70 can extend radially a length (L) from the longitudinal axis 54 at a center of the filter element 50 to the apex 72. The length (L) can be larger, smaller, or the same length as a radius of curvature (R) of the bottom portion 68. For instance, in one example, the length (L) may not be equal to the radius of curvature (R), such that the top surface of the filter element 50 is farther or shorter from the center of the filter element 50 than the bottom surface of the filter element 50. The top portion 70 can be tapered, such that the top portion 70 gradually decreases in width along the length (L) in a direction substantially perpendicular to the longitudinal axis 54 away from a center of the filter element 50 towards the apex 72. The top portion 70 can decrease in width in a direction substantially perpendicular to the longitudinal axis 54 until reaching a minimum width at the apex 72. It is to be understood that the top portion 70 is somewhat generically represented in the shown examples, and can include a variety of sizes and shapes. For instance, the top portion 70 can be longer or shorter in length (L). Similarly, the top portion 70 can gradually taper, such that side walls of the top portion 70 are generally linear. In other examples, side walls of the top portion 70 can be generally non-linear, such as by having a concave or convex curve. It is to be appreciated that the shape of the filter element 50 (e.g., droplet shaped cross-section with tapered top portion and rounded bottom) helps to prevent dust accumulation. Gravity provides a force that urges the dust particles to fall from the filter element.

While the droplet shape of the filter element 50 can include the top portion 70 having a length (L) from the longitudinal axis 54 towards the apex 72, it is to be understood that the droplet shape having a substantially non-circular shape is not limited to such an example. In further examples, the filter elements 50 may not be oriented with the apex 72 faced upwardly (i.e., perpendicular to a horizontal plane). Instead, the filter elements 50 can have different rotational orientations with respect to the longitudinal axis 54 with the top portion 70 still retaining the substantially non-circular shape. In these examples, the apex 72 could be slightly offset from an upward orientation, such that the apex 72 is oriented in a substantially upward orientation. The apex 72 could be offset from a vertical plane extending through the longitudinal axis 54 in a range from about +/−45° with respect to the vertical plane. For instance, a vertical plane can extend directly upwardly from the longitudinal axis 54. The top portion 70 including the apex 72 can be offset from the vertical plane such that the apex 72 can form an angle with respect to the vertical plane in the range from about +/−45°. It is to be understood, however, that further angles and orientations are envisioned.

The operation of the filter element 50 can now be described. Referring first to FIG. 1, dust flow 15 can enter the filtration arrangement 10 through the opening 26 in the bottom panel 24. The fan assembly 40 can create a negative pressure in the filter elements 50 and in the filter housing 16. As such, the dust flow 15 can be drawn through the filter elements 50, causing the air to be filtered by the filter elements 50. The filtered air 52 can then be drawn from the filter elements 50 and into the end wall assembly 34 through the filter openings 36. The fan assembly 40 can further draw the filtered air 52 through the fan opening 38, whereupon the filtered air 52 can exit through the fan outlet 42.

In further examples, the size and shape of a cross-section of the filter elements 50 can be optimized. More specifically, the length (L) of the top portion 70 and radius of curvature (R) of the bottom portion 68 can be optimized based on a number of factors, including, but not limited to, air speed, particle size, particle mass, filter media porosity, temperature, humidity, etc. As such, filter elements 50 can be provided that can increase and/or maximize the shedding of dust or particulate matter, while simultaneously maintaining an acceptable size, backpressure, and the like. Accordingly, varying sizes and shapes of filter elements 50 can be provided in different filtration arrangements 10, with the filter elements 50 being designed to perform optimally within the specific environment of the filtration arrangement 10.

Referring now to FIGS. 2 and 3, the filter element 50 operation can be described in more detail. Dust flow 15 can be filtered by passing through the filter media 64 and, and then the scrim 60. The dust flow 15 passing through the filter media 64 is filtered due, at least in part, to the filtering capabilities of the filter media 64. As such, particles, including dust, and/or liquid can accumulate on the outer surface of the filter media 64 while the cleaned/filtered air passes through the scrim 60 and into the central passageway 62. It is to be understood that the dust flow 15 can pass through the filter media 64 at nearly any location along through the filter element 50, such as through a top surface, bottom surface, side surface, or the like.

The particles that have been filtered by the filter media 64 can collect on the outer surface of the filter media 64. Due at least in part to the droplet shape of the filter element 50, a reduced amount of particle accumulation or buildup can occur at top portion walls 71 of the top portion 70. The relatively steep angle of the top portion walls 71 can allow particles to naturally fall from the filter element 50 under the influence of gravity. Additionally, the length (L) can be adjusted such that a longer length (L) is provided to present a steeper angle of the top portion walls 71, thereby increasing the removal of particulates by the force of gravity. Similarly, the downward orientation of the pleats 65 can also assist in allowing the particulates to fall from the filter media 64. The apex 72 can also define a relatively thin edge at the top of the filter element 50, such that a reduced particle buildup can occur at the top of the filter element 50. Accordingly, the droplet shape of the filter element 50 can reduce and/or prevent particle buildup from accumulating on the filter element 50.

By reducing the particle buildup at the top portion 70, the filter element 50 can exhibit a number of benefits. For instance, the filter element 50 can have an improved efficiency due to a larger effective filtering surface area, such that more air can be filtered. The filter element 50 can remain in operation for longer periods of time with less downtime for cleaning. Further, pressure drop can also be decreased across the filter media 64 as well, due to less particle buildup on the outer surface of the filter media 64. Even further, by limiting the particle buildup at the top portion 70 of the filter media 64, the filter element 50 can exhibit a longer life due to less wear. Wear can occur, at least in part, due to the accumulation of particles along a top surface and top-side surfaces.

Referring now to FIG. 4, an example of a filter element 150 in accordance with the prior art is shown. The filter element 150 can include a scrim 160 and a filter media 164 disposed on the scrim 160. The filter media 164 can be made of a variety of filtering materials including hydrophobic filtering materials. The scrim 160 is cylindrically shaped and extends along a longitudinal axis 154. As such, the filter element 150 includes a circularly shaped cross-section. In operation, the filter element 150 can filter particles, including dust, and/or liquids from air/dust flow that passes through the filter media 164. The particles that are filtered and removed from the air/dust flow can accumulate at a top portion 170 of the filter element 150. The top portion 170 of the filter element 150 includes a half-circle shape with a rounded apex. Accordingly, particles can buildup and accumulate at the top portion 170 and are limited from falling off the filter element 150 under the influence of gravity. This particle buildup can limit and/or prevent air flow through the filter element 150 at the top portion 170. Further, the particle buildup can cause a relatively high pressure drop across the filter element 150. Accordingly, the filter element 50 of the present invention having a droplet shaped cross-section can reduce the aforementioned drawbacks of the prior art filter element.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A filter element including:
a filter media extending along a longitudinal axis and extending circumferentially about a central passageway that extends along the longitudinal axis, the filter media defining a droplet cross-sectional shape perpendicular to the longitudinal axis.

2. The filter element of claim 1, further including a scrim located radially within the filter media to prevent radial inward movement of the filter media into the central passageway, the scrim defining a droplet cross-sectional shape perpendicular to the longitudinal axis.

3. The filter element of claim 1, wherein the longitudinal axis extends along a substantially horizontal direction in a range from about +/−45° with respect to a horizontal plane.

4. The filter element of claim 1, wherein the filter media includes a top portion defining a non-circular shape.

5. The filter element of claim 1, wherein the filter media further includes a bottom portion defining a substantially non-linear shape.

6. The filter element of claim 1, wherein the filter element is rotationally oriented about the longitudinal axis such that a top portion of the filter element extends at an angle with respect to a vertical axis in a range of from about +/−45°.

7. The filter element of claim 6, wherein the top portion is configured such that the defined cross-sectional area decreases in cross-sectional width as the top portion extends from the longitudinal axis toward the apex of the top portion.

8. The filter element of claim 7, wherein the top portion is tapered toward the apex, the apex including an internal angle of less than 90°.

9. The filter element of claim 1, wherein the filter media includes a plurality of pleats extending in a downward direction towards a bottom portion of the filter media and away from a top portion of the filter media.

10. A filter element including:
a filter media extending along a longitudinal axis and circumferentially about a central passageway that extends along the longitudinal axis, the filter media defining a top portion shape and a bottom portion shape, the top and bottom portion shapes being asymmetric with respect to each other in a cross-sectional plane that is perpendicular to the longitudinal axis.

11. The filter element of claim 10, wherein the bottom portion is rounded having a radius of curvature (R) from the longitudinal axis, and an apex of the top portion is spaced a length (L) from the longitudinal axis with the length (L) being different from the radius of curvature (R).

12. The filter element of claim 10, wherein the top portion is configured such that the defined cross-sectional area decreases in cross-sectional width as the top portion extends from the longitudinal axis toward the apex of the top portion.

13. The filter element of claim 10, wherein the top portion includes a tapered end having an internal angle less than 90°.

14. The filter element of claim 10, wherein the top portion forms a top surface of the filter element, further wherein the bottom portion forms a bottom surface of the filter element.

15. The filter element of claim 10, wherein the top portion includes opposing top portion walls, the top portion walls including a substantially linear shape.

16. A filtration arrangement for filtering dust flow, the filtration arrangement including:
a filter housing including an opening through which dust flow is configured to enter the filter housing; and
a filter media extending along a longitudinal axis and extending circumferentially about a central passageway that extends along the longitudinal axis, the filter media defining a droplet cross-sectional shape perpendicular to the longitudinal axis.

17. The filtration arrangement of claim 16 further including a scrim located radially within the filter media to prevent radial inward movement of the filter media into the central passageway, the scrim defining a droplet cross-sectional shape perpendicular to the longitudinal axis.

18. The filtration arrangement of claim 16, wherein the longitudinal axis extends along a substantially horizontal direction.

19. The filtration arrangement of claim 16, wherein the filter media includes a top portion defining a non-circular shape.

20. The filtration arrangement of claim 19, wherein the filter media further includes a bottom portion defining a substantially semi-circular shape.
